(19) United States
(12) Patent Application Publication
(10) Pub. No.: US 2005/0236748 A1
(43) Pub. Date: Oct. 27, 2005

(54) Roll-down tube for a pneumatic spring

(75) Inventors: Alexander Gross, Bischofsheim (DE); Holger Gubitz, Schweinfurt (DE); Thomas Nowotka, Ebelsbach (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG

(21) Appl. No.: 11/111,448

(22) Filed: Apr. 21, 2005

(30) Foreign Application Priority Data
Apr. 22, 2004 (DE) 10 2004 020 211.7
Jul. 1, 2004 (DE) 10 2004 031 873.5

(51) Int. Cl. F16F 9/04

(52) U.S. Cl. 267/64.27; 267/64.24

(57) ABSTRACT

A roll-down tube for a pneumatic spring which is fitted to a shock absorber having a cylinder tube and a piston rod, the roll-down tube having an internal contour which is fitted to the cylinder tube and a longitudinal axis corresponding to the piston rod. The pneumatic spring includes a rolling bellows having one end fitted to a cap fixed to the piston rod and another end fixed to the roll-down tube, the roll-down tube being formed by two molded plastic shells which are fitted together.

### BACKGROUND OF THE INVENTION

1. Field of the Invention

The invention relates to a roll-down tube for a pneumatic spring which is fitted to a shock absorber having a cylinder tube and a piston rod, the roll-down tube having an internal contour which is fitted to the cylinder tube and a longitudinal axis corresponding to the piston rod, the pneumatic spring including a rolling bellows having one end fitted to a cap fixed to the piston rod and another end fixed to the roll-down tube.

2. Description of the Related Art

A roll-down tube for a pneumatic spring is known from DE 88 13 045 U1. The roll-down tube consists of plastic, where the essential advantage is that the relatively complicated roll-down contour and a high-quality surface finish can be produced more cheaply out of plastic than out of metal. The roll-down tube described in DE 88 13 045 U1 has a comparatively simple internal contour with undercut-free axial webs. If, when this design principle is applied, the mid-section of the roll-down tube is pulled inward to a significant degree, it is impossible to avoid areas with increased concentrations of material. This extra material increases the cost of production, increases the weight of the component, and also interferes with the injection-molding properties, because a nonuniform distribution of material means that the rate at which the material inside the component cools will differ from one place to another. In addition, it can be expected that the component will warp, so that, under certain conditions, it will be impossible to obtain the desired dimensional accuracy. A possible solution to this problem would be to prolong the cycle by allowing more time for cooling.

### SUMMARY OF THE INVENTION

The object of the present invention is to improve the roll-down tube for a pneumatic spring in such a way that the roll-down tube can have even more complicated internal contours.

According to the invention, the roll-down tube is formed by two individual shell-like elements of injection molded plastic.

The great advantage of the invention is that a more functional internal contour can be produced, regardless of the way in which the roll-down tube itself is manufactured. In the case of a roll-down tube made out of injection-molded plastic, therefore, more favorable material distributions can be provided and more favorable stiffening ribs obtained.

It is simpler, in general, for the parting line to be parallel to the longitudinal axis of the roll-down tube. For the purpose of improving the seal between the individual shell-like elements, however, at least one parting line between the individual elements should extend at an angle to the longitudinal axis. When an axial load acts on the individual elements, the elements will thus be clamped together in the area of the parting line.

In another advantageous embodiment, sealing means are provided between the individual elements. When the sealing means are sprayed onto the individual element, the contour of the parting line(s) can be designed with greater freedom, because there is no need to depend on prefabricated sealing strips or sealing rings. The extra labor required to install a separate sealing ring is also eliminated.

It is also provided that one of the individual elements has at least one axial support surface for at least one other individual element. The axial support surface prevents the two individual elements from being pushed beyond their final assembly position with respect to each other.

In addition, at least one locking means on at least one of the individual elements secures the individual elements with respect to each other in their final assembly position. The roll-down tube thus forms a closed structural unit.

An effective way to prevent the locking means from being opened is to design the locking means in the form of at least one snap hook, which acts on the minimum of one other individual element.

In addition, an individual element has at least one radial retaining element for the minimum of one other individual element. Thus, after assembly has been completed, the roll-down tube cannot come apart under the action of radial loads.

It is also possible for the individual elements of the roll-down tube to be secured by a retaining ring. The retaining ring can be formed, for example, by a collar band for the rolling bellows of the pneumatic spring.

As an alternative, at least one of the individual elements can have fastening means which enter into a working connection with the retaining ring.

The working connection between the retaining ring and the minimum of one individual element can be formed by pins, for example, which fit into holes. It is advisable for at least two individual elements to have these pins and to be held in place with respect to each other in the radial direction by the retaining ring.

So that the working connection cannot come apart by itself during the operation of the pneumatic spring, the pins are provided with latching elements. The latching elements are designed to act like barbs.

The retaining ring can also be used to exert a clamping force on the rolling bellows of the pneumatic spring.

So that the clamping force which the retaining ring must exert can be kept small, the roll-down tube has a circumferential edge, over which the rolling bellows is inverted, and the retaining ring clamps the rolling bellows against the roll-down tube. The pressure inside the rolling bellows and the frictional force between the rolling bellows and the roll-down tube reinforce the clamping effect.

In addition, independently of the sealing and locking means, it is also possible for the individual elements to be welded to each other or bonded to each other with an adhesive.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is an overall cross-section of a pneumatic spring;

FIG. 2 is an exploded perspective view of an inventive roll-down tube for a pneumatic spring;

FIG. 3 shows a partial view in illustration of an axial support surface;

FIG. 4 shows how the retaining ring of the roll-down tube functions;

FIG. 5 shows a detail of FIG. 4;

FIG. 6 shows a cross-sectional view of FIG. 4; and

FIG. 7 shows part of FIG. 6.

### DETAILED DESCRIPTION OF THE PRESENTLY PREFERRED EMBODIMENTS

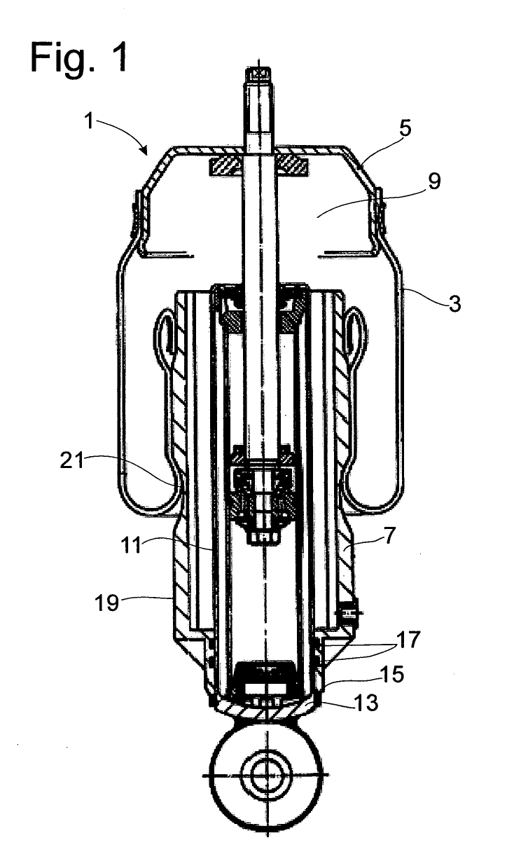

FIG. 1 shows a pneumatic spring 1 such as that known from DE 88 13 045 U1. The pneumatic spring 1 includes a rolling bellows 3, one end of which is connected by a clamping ring to a cap 5, whereas the other end is connected to a roll-down tube 7. The sealed cap 5, the rolling bellows 3, and the roll-down tube 7 define a gas-filled spring space 9, which exerts a load-bearing force. In this application example of a pneumatic spring, a vibration damper is mounted coaxially to the roll-down tube; this damper has a container tube 11, to which a support ring 13 is attached. The roll-down tube is supported axially by its bottom end surface 15 against the container tube. So that no pressure can be lost, the pneumatic spring has at least one sealing ring 17.

During a force-absorbing movement, the rolling bellows rolls down along the outside wall 19 of the roll-down tube. The necked-down section 21 makes the spring force characteristic of the pneumatic spring dependent on the stroke distance.

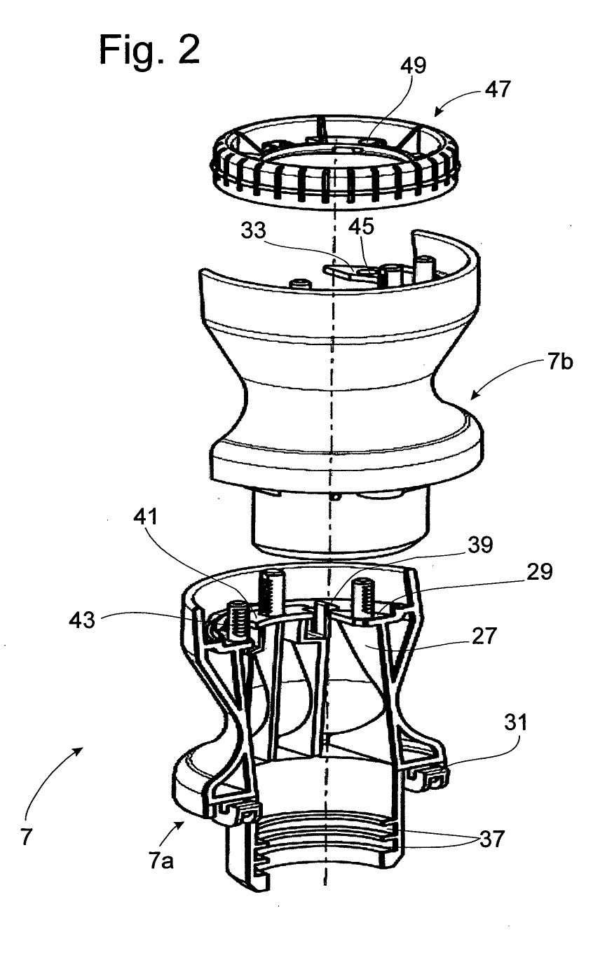

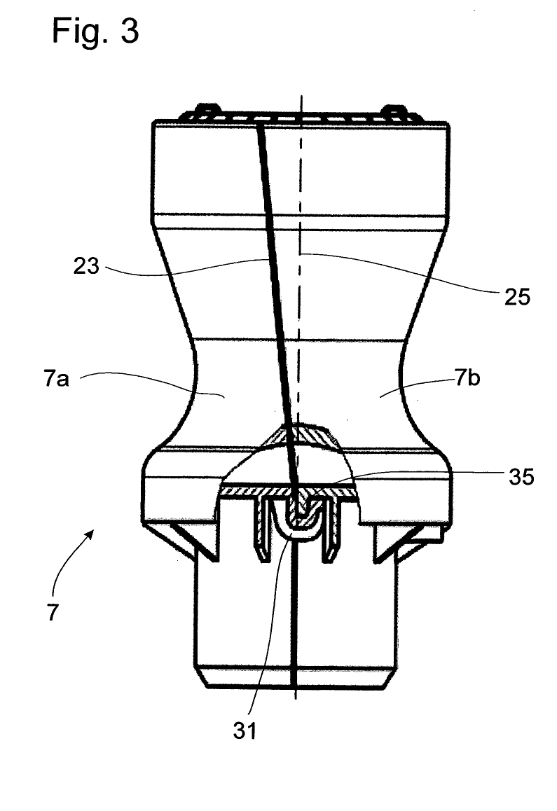

FIG. 2 shows an exploded diagram of the inventive roll-down tube 7. As can be derived from the drawing, the roll-down tube 7 consists of two individual shell-like elements 7a, 7b. A parting line 23 is located parallel, or preferably at an angle, to the longitudinal axis 25 of the roll-down tube, as can be seen in FIG. 3. On the inside wall of the individual elements, stiffening ribs 27 can be formed, which preferably extend transversely to the parting plane defined by the parting line. The roll-down tube consists of a plastically formable material such an injection-moldable plastic. This orientation of the stiffening ribs allows the individual elements to be removed easily from the mold.

During the assembly process, the two individual elements 7a, 7b are positioned axially with respect to each other. The axial support surfaces 29, 31 on the individual elements play their part here. In the assembled state, a retaining web 33 thus rests on the axial support surface 29. FIG. 3 shows how the axial support surface 31 functions. This surface is designed in the form of a finger, into which a support web 35 on the individual element 7b fits. The finger-like axial support surface 31 also acts as a radial retainer, which prevents the two individual elements from moving apart. It can also be seen in FIG. 2 that it is easy to produce annular grooves 37 for the sealing rings 17 (shown in FIG. 1).

On an upper end surface 41 of the individual element 7a, a locking means in the form of at least one snap hook 39 is located, which holds the individual elements in position with respect to each other after assembly. Axially oriented pins 43, which fit into holes 45 in the retaining webs 33 and thus enter into working connection with them, are also provided on the upper end surface 41. The pins and the holes in conjunction with the retaining webs also act as radial retainers, so that the individual elements can form a closed structural unit.

As an alternative to a radially acting clamping ring for the rolling bellows, it is also possible to use a retaining ring 47, which enters into working connection with the pins 43. The pins 43 fit into the clamping openings 49 in the retaining ring 47 and thus act as fasteners. In order to mount the retaining ring so that it cannot work itself loose, the pins are provided with sawtooth-like latching elements.

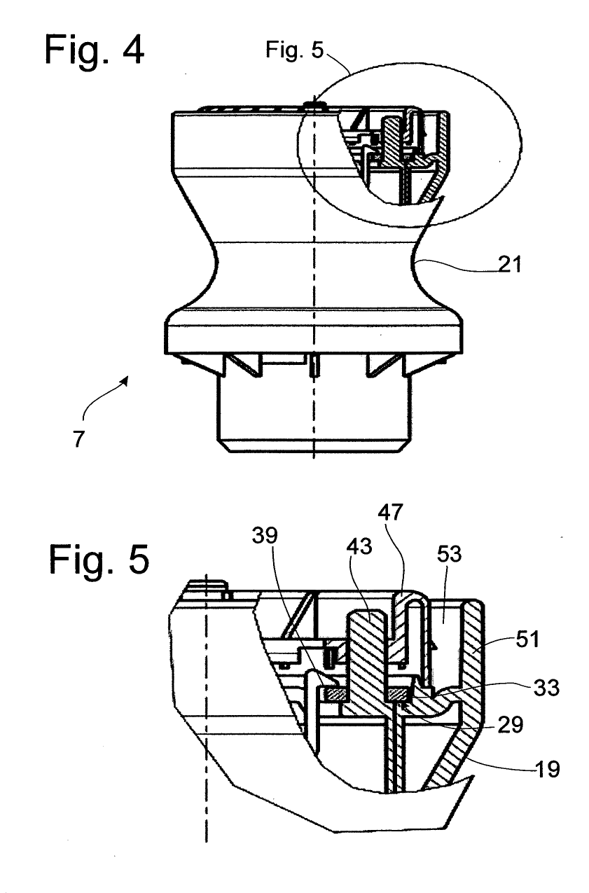

FIG. 4 shows the roll-down tube 7 after final assembly. From the enlarged view in FIG. 5, it can be seen that the retaining web 33 rests on the axial support surface 39, and that the pins 43 are in working connection with the retaining ring 47. In addition, the snap hooks 39 are also in the secured position, that is, they are also supported on the retaining web and thus prevent the two individual elements from shifting position in the axial direction.

The roll-down tube 7 has a circumferential edge 51 with an inside surface which works together with the outside surface of the retaining ring 47 to form an annular channel 53. The end of the rolling bellows according to FIG. 1 is introduced into the annular channel and inverted over the edge 51, so that it can rest against the outside wall 19. The retaining ring 47 can then clamp the rolling bellows to the roll-down tube.

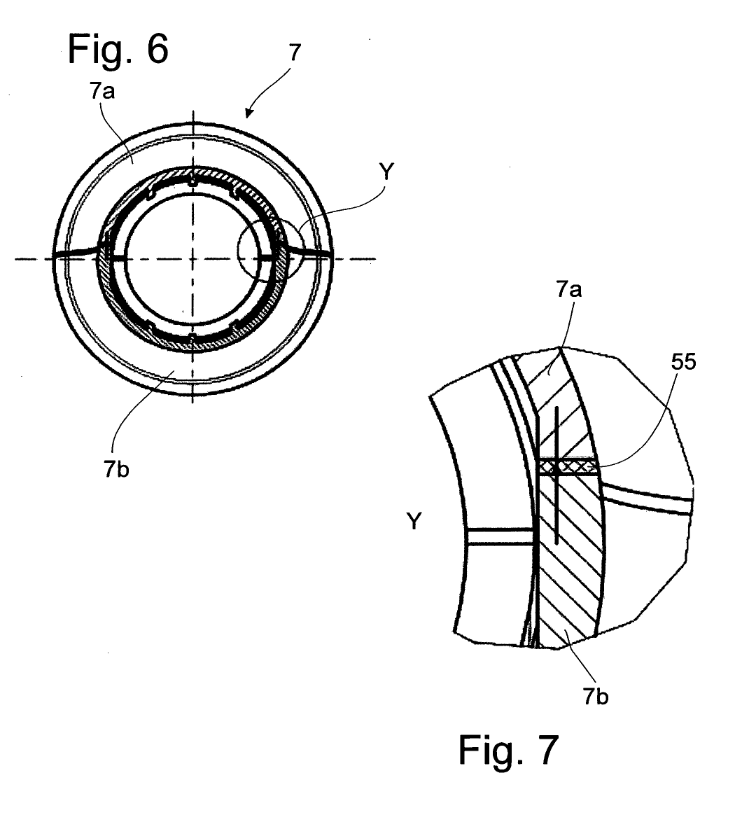

FIG. 6 shows a cross section through the roll-down tube near the necked-down area 21. In the enlarged view according to FIG. 7, it can be seen that sealing means 55 are provided inside the joint between the individual elements 7a, 7b; for example, a soft material is sprayed onto the joint surfaces. Alternatively or in addition, it is possible to weld the individual elements together at this point or to bond them together with an adhesive in order to prevent the loss of pressure from the spring space.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A roll-down tube for a pneumatic spring which is fitted to a shock absorber having a cylinder tube and a piston rod, the roll-down tube having an internal contour which is fitted to the cylinder tube and a longitudinal axis corresponding to the piston rod, the pneumatic spring comprising a rolling bellows having one end fitted to a cap fixed to the piston rod and another end fixed to the roll-down tube, the roll-down tube comprising two molded plastic shells which are fitted together.

2. The roll-down tube of claim 1 wherein the shells are fitted together along at least one parting line in a plane at an acute angle to a plane through the longitudinal axis.

3. The roll-down tube of claim 1 further comprising a seal between the shells.

4. The roll-down tube of claim 3 wherein the seal is sprayed onto the shells.

5. The roll-down tube of claim 1 wherein each said shell comprises at least one axial support surface which supports the other shell axially.

6. The roll-down tube of claim 5 wherein at least one of said shells has at least one axial locking element which engages the other said shell to hold the shells together.

7. The roll-down tube of claim 6 wherein the locking element comprises a snap hook.

8. The roll-down tube of claim 1 wherein at least one of said shells has at least one radial retaining element which engages the other said shell to hold the shells together axially.

9. The roll-down tube of claim 1 further comprising a retaining ring which secures the shells together radially.

10. The roll-down tube of claim 9 wherein at least one of said shells has a fastener which engages the retaining ring.

11. The roll-down tube of claim 10 wherein the at least one fastener comprises pins which engage in holes in the retaining ring.

12. The roll-down tube of claim 11 wherein the pins have latching elements which engage the retaining ring.

13. The roll-down tube of claim 9 wherein the retaining ring clamps the rolling bellows against the shells.

14. The roll-down tube of claim 13 comprising a circumferential edge formed by the shells, the rolling bellows being inverted over the circumferential edge.

15. The roll-down tube of claim 1 wherein the shells are welded together.

16. The roll-down tube of claim 1 wherein the shells are bonded together by adhesive.
